(19) United States
(12) Patent Application Publication
(10) Pub. No.: US 2022/0344716 A1
(43) Pub. Date: Oct. 27, 2022

(54) Organic-Electrolyte Lithium-Oxygen Battery With Full-Enclosed Structure And Preparation Method Thereof

(71) Applicant: Changzhou University, Changzhou City (CN)

(72) Inventors: Kun Luo, Changzhou City (CN); Xiangqun Zhuge, Changzhou City (CN); Wenxiang Chen, Changzhou City (CN); Zhengping Ding, Changzhou City (CN)

(73) Assignee: Changzhou University, Changzhou City (CN)

(21) Appl. No.: 17/514,938

(22) Filed: Oct. 29, 2021

(30) Foreign Application Priority Data
Apr. 26, 2021 (CN) 202110451817.0

(51) Int. Cl. H01M 10/0568; H01M 4/04; H01M 10/052; H01M 10/0569; H01M 10/44; H01M 50/30

(52) U.S. Cl. CPC H01M 10/0568; H01M 4/0404; H01M 10/052; H01M 10/0569; H01M 10/44; H01M 50/30; H01M 2004/028

(57) ABSTRACT

An organic-electrolyte lithium-oxygen battery with a full-enclosed structure and a preparation method thereof are disclosed. In the present disclosure, a lithium-oxygen battery unit is enclosed in a shell containing pure oxygen, and the reactant oxygen is recycled without additional supply. Among them, a part of oxygen is stored in the form of lithium peroxide by pre-discharging. When in use, a charging is firstly performed to decompose the lithium peroxide to release the fixed oxygen.

### CROSS REFERENCE TO RELATED APPLICATION

This patent application claims the benefit and priority of Chinese Patent Application No. 202110451817.0 filed on Apr. 26, 2021, the disclosure of which is incorporated by reference herein in its entirety as part of the present application.

### TECHNICAL FIELD

The present disclosure belongs to the field of electrochemical energy source, and relates to the technology of lithium-oxygen batteries. A lithium-oxygen battery with a full-enclosed structure is designed to operate the battery in a pure oxygen environment without being affected by the external environment and improve the cycle performance.

### BACKGROUND ART

The “range anxiety” caused by automobile power batteries and the requirements to energy storage in the utilization of such as wind-electricity and solar energy have prompted people to continuously explore new ways to increase the energy density of batteries. Lithium has an high specific capacity (3860 mAh·g⁻¹), the most negative standard electrode potential (−3.04 V) and an extremely low density (0.534 g·cm⁻³). When lithium is used in combination with oxygen, a lithium-oxygen battery is formed that produces high specific energy (about 3460 Wh·kg⁻¹), and has an environmentally friendly working mode (absorbing oxygen during discharging and releasing oxygen during charging), therefore has drawn widespread attentions. The oxygen required for the reaction in a lithium-oxygen battery is generally derived from oxygen in the air, so it is also called a lithium-air battery.

Lithium-oxygen batteries may be divided into four types: the organic electrolyte, the solid electrolyte, the mixed electrolyte and the aqueous electrolyte. Among them, the organic-electrolyte lithium-oxygen battery is the most common, and reactions of lithium deposition/dissolution occur mainly in the negative electrode thereof. Due to the active chemical properties of lithium, the organic electrolyte should be subjected to a water removal treatment. The processes in the positive electrode are relatively complicated. During the discharging process of the battery, an oxygen reduction reaction occurs on the surface of the positive electrode to form solid lithium peroxide; during the charging process, lithium peroxide is decomposed to generate lithium ions and release oxygen.

Some technical problems may appear during the charge-discharge cycles in the lithium-oxygen batteries. In terms of the negative electrode, the dissolution/deposition process of the metallic lithium is prone to form dendrites, which leads to the volume expansion of the negative electrode, the formation of “dead lithium” without electrical contact, and even the short circuit of the positive and negative electrodes. In terms of the positive electrode, the solid-state product lithium peroxide during discharging is not conductive, and is difficult to be totally decomposed during the charging process, leading to continuous accumulation until the positive electrode is completely covered, and thus the battery is invalid. In terms of the electrolyte, the intermediate products of the oxygen reduction reaction (such as superoxide ions and antozones) have strong oxidizability, which may decompose the organic electrolyte, and further lead to formation of hard-to-decompose products such as lithium hydroxide and lithium carbonate on the positive electrode, and the corrosion of the lithium negative electrode as well.

For these problems, various solutions have been proposed. For example, by densifying the structure of the SEI film on the surface of lithium, by preparing the artificial protective layer and the like, the deposition/dissolution of lithium in the negative electrode may be homogenized, and corrosive substances may be shielded from contacting lithium metal. For another example, by using ethers or sulfones organic solvents with good chemical stability to prepare the electrolyte and adding such as redox mediators to enhance the decomposition of lithium peroxide, the electrolyte may be protected from nucleophilic attack by the superoxide ions and antozones. In addition, membranes that have a barrier effect on moisture and dissolved oxygen are also used to prevent the harmful substances from entering the negative electrode chamber and protect the lithium negative electrode.

However, lithium-oxygen batteries generally have an open structure due to the use of oxygen in the air for the reaction in the positive electrode, which causes a series of problems. For example, the moisture, carbon dioxide and even nitrogen in the air may participate in the electrochemical reactions, so that the products during discharging are complex in composition and difficult to be decomposed during charging, decreasing the reaction reversibility of the lithium-oxygen batteries. For this reason, people need to invest a lot of energy in the development of moisture and gas separation membranes to ensure that only oxygen participates in the reactions in batteries. However, this work is difficult, and there is little research progress currently. In addition, the open structure also leads to the loss of electrolyte via volatilization, which is not conducive to the long-term and stable operation of batteries, and causes safety hazards and environmental pollutions.

### SUMMARY

The present disclosure provides a lithium-oxygen battery with a full-enclosed structure. The lithium-oxygen battery unit with an open structure is enclosed in a battery shell full of pure oxygen, so that the lithium-oxygen battery could work stably without being affected by changes in the external environment, and also the volatilization of the electrolyte may be inhibited, improving the cyclic performance of the battery.

The present disclosure provides the following technical schemes:

An organic-electrolyte lithium-oxygen battery with a full-enclosed structure is disclosed, which comprises a battery pack shell 1, a lithium-oxygen battery unit 2, a gas inlet 3, a gas outlet 4, a positive electrode terminal 5 and a negative electrode terminal 6; wherein,

the gas inlet 3 and the gas outlet 4 are arranged on the battery pack shell 1 and connected with valves, and may be connected with an oxygen cylinder and a vacuum pump, respectively;

the lithium-oxygen battery unit 2 is located inside the battery pack shell 1 and includes a unit shell 21, a lithium-oxygen battery cell 22 and a battery cell groove 23, and the lithium-oxygen battery cell 22 is placed in the battery cell groove 23; the lithium-oxygen battery cell 22 includes a silica gel tank 221, a negative electrode current collector 222, a lithium sheet negative electrode 223, a separator 224, a positive electrode 225, a positive electrode current collector 226 and a gas guide groove 227 arranged in sequence; the positive electrode current collector 226 and the negative electrode current collector 222 are respectively connected with the positive electrode terminal 5 and the negative electrode terminal 6 through busbars; the silica gel tank 221 is composed of a back cover 2211 and a frame 2212 in structure; and a transverse gas flow channel 2271 and a longitudinal gas flow channel 2272 are arranged on both sides of the gas guide groove 227, and a through hole 2273 is arranged at intersection of the transverse gas flow channel 2271 and the longitudinal gas flow channel 2272.

A method for preparing an organic-electrolyte lithium-oxygen battery with a full-enclosed structure is also disclosed, comprising:

1. Preparation of an Electrolyte:

drying a supporting electrolyte in a vacuum drying oven at a temperature of 100-180° C. for 12-24 h before use; and in a glove box, dissolving the dried supporting electrolyte in an organic solvent to prepare an electrolyte with a concentration of 0.1-5.0 mol/L, adding an activated molecular sieve to remove trace amount of moisture in the electrolyte, and then sealing and storing the electrolyte in the glove box for later use;

2. Assembly of a Battery:

under protection of argon, assembling a silica gel tank 221, a negative electrode current collector 222, a lithium sheet negative electrode 223, a separator 224, a positive electrode 225, a positive electrode current collector 226 and a gas guide groove 227 in sequence into a lithium-oxygen battery cell 22 with an open structure, and adding dropwise the electrolyte to the separator 224 in 0.1-0.4 mL/cm², based on a geometric area of the positive electrode; arranging the lithium-oxygen battery cells 22 in sequence and assembling into corresponding battery cell grooves 23 in a unit shell 21, and connecting the positive electrode current collector 226 and the negative electrode current collector 222 with a positive electrode terminal 5 and a negative electrode terminal 6 through busbars respectively to export current to the outside of a battery pack shell 1; and sealing the battery pack shell 1 and checking air-proof of the battery;

3. Battery Formation:

arranging a gas inlet 3 and a gas outlet 4 with a control valve provided for each on the battery pack shell 1; connecting the gas inlet 3 with an oxygen cylinder and connecting the gas outlet 4 with a vacuum pump; firstly, opening the gas-outlet valve, starting the connected vacuum pump, exhausting the gas inside the battery pack shell 1, and closing the gas-outlet valve when reaching 0.01-0.05 MPa; then opening the gas-inlet valve, introducing oxygen to fill the battery pack shell 1 with pure oxygen, and keeping at a pressure of 1 atm to complete a gas exchanging operation once; and repeating the gas exchanging operation for 1-3 times;

allowing the battery to stand for 10-20 h, and activating by charge-discharge cycles for 5-20 times with a low current density of 0.001-0.01 mA/cm² and a small capacity of 10-500 mAh/m², based on the geometric area of the positive electrode; then discharging with a current density of 0.01-0.1 mA/cm² and a capacity of 100-5000 mAh/m²; after completing the discharging, performing the gas exchanging operation once; and closing the gas inlet 3 and the gas outlet 4 of the lithium-oxygen battery to make the battery in a full-enclosed state to complete the battery formation.

In some embodiments, the supporting electrolyte is selected from the group consisting of lithium perchlorate (LiClO₄), lithium bis(trifluoromethanesulphonyl)imide (LiTFSI), lithium nitrate (LiNO₃), lithium hexafluorophosphate (LiPF₆) and lithium tetrafluoroborate (LiBF₄).

In some embodiments, the organic solvent is selected from the group consisting of dimethyl ether (DME), dimethyl sulfoxide (DMSO) and tetraethylene glycol dimethyl ether (TEGDME).

In some embodiments, the prepared organic-electrolyte lithium-oxygen battery with a full-enclosed structure is pre-charged before use, under the conditions that the current density is of 0.1-1 mA/cm² and the capacity is of 500-5000 mAh/m²; and then the lithium-oxygen battery is allowed to be used normally, under the charging and discharging conditions that the current density is of 0.1-1 mA/cm² and the capacity is of 500-5000 mAh/m², based on the geometric area of the positive electrode, and does not need to be supplemented with oxygen during charge-discharge cycles.

The present disclosure has the following beneficial effects:

(1) Unlike the conventional lithium-oxygen batteries with an open structure, in the method of the present disclosure, the lithium-oxygen battery unit is enclosed in a shell containing pure oxygen, and the reactant oxygen is recycled without need of additional supply. Among them, a part of oxygen is stored in the form of lithium peroxide by pre-discharging. When in use, a charging is firstly performed to decompose the lithium peroxide to release the fixed oxygen, so that during the cycle of the battery, the oxygen pressure inside the battery is always maintained at 1 atm.

(2) In the method of the present disclosure, the lithium-oxygen battery unit is enclosed in the shell, which solves the influence of the environmental factors such as humidity and carbon dioxide, and allows the lithium-oxygen battery working stably. At the same time, the volatilization of the electrolyte may be controlled, so that the battery may maintain long-term and stable operation.

(3) The lithium-oxygen battery with a full-enclosed structure could meet the requirements for the service conditions of power batteries and energy storage batteries, has a small influence on environment, and is suitable for various natural environments.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

These drawings illustrate certain aspects of some of the embodiments of the present invention and should not be used to limit or define the invention.

FIG. 1 shows a structure diagram of the organic-electrolyte lithium-oxygen battery with a full-enclosed structure.

FIG. 2 shows the unit group of the organic-electrolyte lithium-oxygen battery with a full-enclosed structure.

FIG. 3 shows a constitution diagram of the battery cell in the organic-electrolyte lithium-oxygen battery with a full-enclosed structure.

FIG. 4 shows the gas guide groove of the battery cell in the organic electrolyte lithium-oxygen battery with a full-enclosed structure.

FIG. 5 shows the silica gel tank of the battery cell in the organic electrolyte lithium-oxygen battery with a full-enclosed structure.

In the figures: 1 battery pack shell, 2 lithium-oxygen battery unit, 3 gas inlet, 4 gas outlet, 5 positive electrode terminal, 6 negative electrode terminal, 21 unit shell, 22 lithium-oxygen battery cell, 23 battery cell groove, 221 silica gel tank, 222 negative electrode current collector, 223 lithium sheet negative electrode, 224 separator, 225 positive electrode, 226 positive electrode current collector, 227 gas guide groove, 2211 back cover, 2212 frame, 2271 transverse gas flow channel, 2272 longitudinal gas flow channel, 2273 through hole.

### DETAILED DESCRIPTION OF THE EMBODIMENTS

### Example 1: The Organic-Electrolyte Lithium-Oxygen Battery with a Full-Enclosed Structure

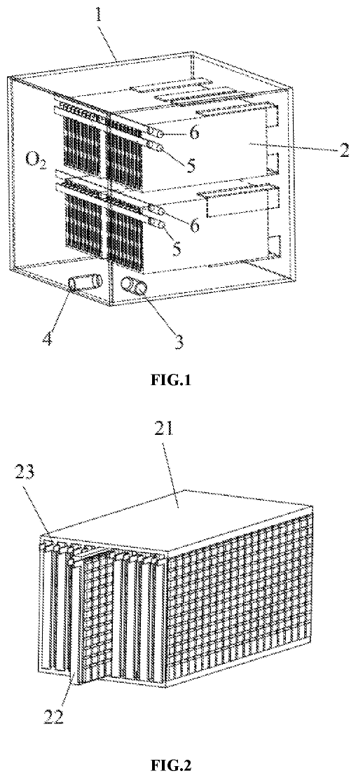

This example describes a method for preparing an organic-electrolyte lithium-oxygen battery with a full-enclosed structure, the structure of which is shown in FIG. 1. The specific scheme is as follows:

The organic-electrolyte lithium-oxygen battery with a full-enclosed structure is shown in the figure, and the structure thereof mainly included: a battery pack shell 1, a lithium-oxygen battery unit 2, a gas inlet 3, a gas outlet 4, a positive electrode terminal 5 and a negative electrode terminal 6; the gas inlet 3 and the gas outlet 4 were each connected with a valve, and might be connected with an oxygen cylinder and a vacuum pump, respectively.

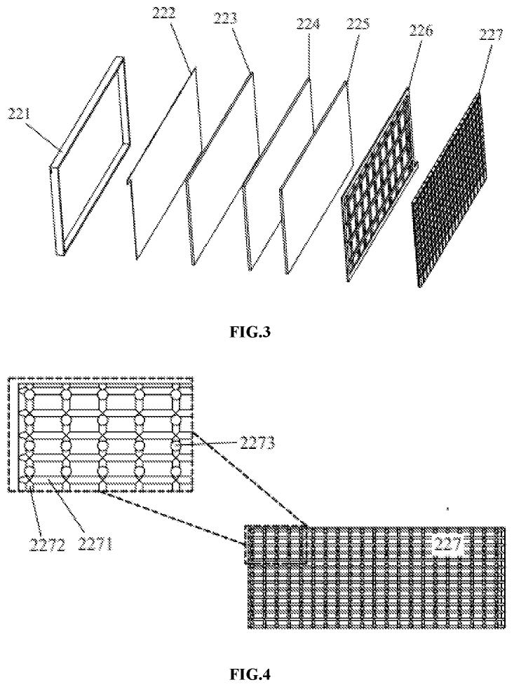

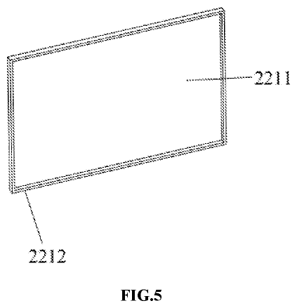

The constitution of the lithium-oxygen battery unit 2 is shown in FIG. 2. The unit group of the organic-electrolyte lithium-oxygen battery with a full-enclosed structure was composed of a unit shell 21, a lithium-oxygen battery cell 22 and a battery cell groove 23.

The constitution of the lithium-oxygen battery cell is shown in FIG. 3. The battery cell was mainly composed of a silica gel tank 221, a negative electrode current collector 222, a lithium sheet negative electrode 223, a separator 224, a positive electrode 225, a positive electrode current collector 226 and a gas guide groove 227. In order to ensure that the gas could reach the positive electrode of the battery evenly, transverse gas flow channels 2271 and longitudinal gas flow channels 2272 were arranged on both sides of the gas guide groove 227, and through holes 2273 were arranged at the intersections of the transverse gas flow channels and the longitudinal gas flow channels on both sides. As shown in FIG. 5, in order to protect the lithium sheet negative electrode from the volatilization or leakage of the electrolyte, the battery cell was encapsulated in a silica gel tank. The silica gel tank was composed of a back cover 2211 and a frame 2212.

The assembly of the organic-electrolyte lithium-oxygen battery with a full-enclosed structure was performed by the following steps:

In accordance with FIG. 3, under the protection of argon, a silica gel tank 221, a negative electrode current collector 222, a lithium sheet negative electrode 223, a separator 224, a positive electrode 225, a positive electrode current collector 226 and a gas guide groove 227 were assembled in sequence into a lithium-oxygen battery cell 22 with an open structure, and 3 mL of LiClO₄ electrolyte in DMSO with a concentration of 1 mol/L (positive electrode area of 15 cm²) was added dropwise to the separator;

8 prepared lithium-oxygen battery cells 22 were assembled into the battery cell grooves 23 in sequence in accordance with FIG. 2 to form a lithium-oxygen battery unit 2. The lithium-oxygen battery units 2 were assembled into a closed battery pack shell 1 in accordance with FIG. 1. The positive and negative electrodes were connected with the corresponding busbars. The lithium-oxygen battery was sealed, and the air-proof of the battery was checked.

Battery Formation:

A gas inlet 3 and a gas outlet 4 with a control valve provided for each were arranged on the battery pack shell 1, wherein the gas inlet 3 was connected with an oxygen cylinder and the gas outlet 4 was connected with a vacuum pump. Firstly, the gas-outlet valve was open, the connected vacuum pump was started to exhaust the gas inside the battery pack shell, and the gas-outlet valve was closed when it reaches 0.05 MPa. Then the gas-inlet valve was open, and oxygen was introduced to make the battery pack shell full of pure oxygen inside. The pressure was kept at 1 atm to complete a gas exchanging operation once. The gas exchanging operation was repeated once.

The battery was allowed to stand for 12 h, then was activated by charge-discharge cycles for 10 times with a low current density of 0.01 mA/cm² and a small capacity of 100 mAh/m² (based on the geometric area of the positive electrode), and discharged with a current density of 0.1 mA/cm² and a capacity of 1000 mAh/m². After the discharging was finished, the gas exchanging operation was performed once. The gas inlet 3 and the gas outlet 4 of the lithium-oxygen battery were sealed to make the battery in a full-enclosed state to complete the battery formation.

Use of the Lithium-Oxygen Battery:

The prepared organic-electrolyte lithium-oxygen battery with a full-enclosed structure was pre-charged before use, under the conditions that the current density was of 0.1 mA/cm² and the capacity was of 1000 mAh/m². Then the lithium-oxygen battery might be used normally, under the charging and discharging conditions that the current density was of 0.1 mA/cm² and the capacity was of 1000 mAh/m² (based on the geometric area of the positive electrode), and did not need to be supplemented with oxygen in the process of charge-discharge cycles.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

What is claimed is:

1. An organic-electrolyte lithium-oxygen battery with a full-enclosed structure, comprising:
a battery pack shell;
a lithium-oxygen battery unit;
a gas inlet, a gas outlet;
a positive electrode terminal; and
a negative electrode terminal;
wherein the gas inlet and the gas outlet are arranged on the battery pack shell and connected with valves, and may be connected with an oxygen cylinder and a vacuum pump, respectively;
wherein the lithium-oxygen battery unit is located inside the battery pack shell and includes a unit shell, a lithium-oxygen battery cell and a battery cell groove, and the lithium-oxygen battery cell is placed in the battery cell groove;
wherein the lithium-oxygen battery cell includes a silica gel tank, a negative electrode current collector, a lithium sheet negative electrode, a separator, a positive electrode, a positive electrode current collector and a gas guide groove arranged in sequence;
wherein the positive electrode current collector and the negative electrode current collector are respectively connected with the positive electrode terminal and the negative electrode terminal through busbars;
wherein the silica gel tank is composed of a back cover and a frame in structure; and a transverse gas flow channel and a longitudinal gas flow channel are arranged on both sides of the gas guide groove, and a through hole is arranged at intersection of the transverse gas flow channel and the longitudinal gas flow channel.

2. A method for preparing an organic-electrolyte lithium-oxygen battery with a full-enclosed structure, comprising:
(1) preparing an electrolyte, wherein the preparing the electrolyte comprises:
drying a supporting electrolyte in a vacuum drying oven at a temperature of 100-180° C. for 12-24 h before use; and in a glove box, dissolving the dried supporting electrolyte in an organic solvent to prepare an electrolyte with a concentration of 0.1-5.0 mol/L, adding an activated molecular sieve to remove trace amount of moisture in the electrolyte, and sealing and storing the electrolyte in the glove box for later use;
(2) assembling a battery, wherein the assembly the battery comprises:
under protection of argon, assembling a silica gel tank, a negative electrode current collector, a lithium sheet negative electrode, a separator, a positive electrode, a positive electrode current collector and a gas guide groove in sequence into a lithium-oxygen battery cell with an open structure, and adding dropwise the electrolyte to the separator in 0.1-0.4 mL/cm², based on a geometric area of the positive electrode;
arranging the lithium-oxygen battery cell in sequence and assembling into a corresponding battery cell groove in a unit shell, and connecting the positive electrode current collector and the negative electrode current collector with a positive electrode terminal and a negative electrode terminal through busbars respectively to export current to the outside of a battery pack shell; and sealing the battery pack shell and checking air-proof of the battery;
(3) forming the battery, wherein the forming the battery comprises:
arranging a gas inlet and a gas outlet with a control valve provided for each on the battery pack shell; connecting the gas inlet) with an oxygen cylinder and connecting the gas outlet with a vacuum pump; firstly, opening the gas-outlet valve, starting the connected vacuum pump, exhausting the gas inside the battery pack shell, and closing the gas-outlet valve when reaching 0.01-0.05 MPa; then opening the gas-inlet valve, introducing oxygen to fill the battery pack shell with pure oxygen, and keeping at a pressure of 1 atm to complete a gas exchanging operation once; and repeating the gas exchanging operation for 1-3 times;
allowing the battery to stand for 10-20 h, and activating by charge-discharge cycles for 5-20 times with a low current density of 0.001-0.01 mA/cm² and a small capacity of 10-500 mAh/m², based on the geometric area of the positive electrode; then discharging with a current density of 0.01-0.1 mA/cm² and a capacity of 100-5000 mAh/m²; after completing the discharging, performing the gas exchanging operation once; and closing the gas inlet and the gas outlet of the lithium-oxygen battery to make the battery in a full-enclosed state to complete the forming the battery.

3. The method of claim 2, wherein the supporting electrolyte is selected from the group consisting of lithium perchlorate, lithium bis(trifluoromethanesulphonyl)imide, lithium nitrate, lithium hexafluorophosphate and lithium tetrafluoroborate.

4. The method of claim 2, wherein the organic solvent is selected from the group consisting of dimethyl ether, dimethyl sulfoxide and tetraethylene glycol dimethyl ether.

5. The method of claim 2, wherein the prepared organic-electrolyte lithium-oxygen battery with a full-enclosed structure is pre-charged before use, under the conditions that the current density is of 0.1-1 mA/cm² and the capacity is of 500-5000 mAh/m²; and then the lithium-oxygen battery is allowed to be used normally, under the charging and discharging conditions that the current density is of 0.1-1 mA/cm² and the capacity is of 500-5000 mAh/m², based on the geometric area of the positive electrode, and does not need to be supplemented with oxygen during charge-discharge cycles.
